(19) United States
(12) Patent Application Publication
(10) Pub. No.: US 2017/0214591 A1
(43) Pub. Date: Jul. 27, 2017

(54) SERVER, SCREEN INFORMATION ACQUISITION METHOD AND BMC

(71) Applicant: NEC Corporation, Tokyo (JP)

(72) Inventor: Takafumi WATANABE, Tokyo (JP)

(21) Appl. No.: 15/416,335

(22) Filed: Jan. 26, 2017

(30) Foreign Application Priority Data
Jan. 27, 2016 (JP) 2016-012980

(51) Int. Cl. H04L 12/26

(52) U.S. Cl. CPC H04L 43/08; H04L 43/04; H04L 67/42

(57) ABSTRACT

Disclosed are a server etc. including: a control device configured to acquire screen information in response to a predetermined input during execution of a process preceding start-up of an Operating System (OS); and a storage device configured to store the screen information.

This application is based upon and claims the benefit of priority from Japanese Patent Application No. 2016-012980, filed on Jan. 27, 2016, the disclosure of which is incorporated herein in its entirety by reference.

### TECHNICAL FIELD

The present invention relates to technology for acquiring history of operations on a server.

### BACKGROUND ART

In recent years, a method called cloud computing has become in wide use. The cloud computing enables us to use applications and computer resources via a network as a service which can be used as necessary, the applications and the computer resources having conventionally been managed and used by means of our own computers until lately.

A provider of such a service installs a large number of servers in a large-scale datacenter or the like, and thereby builds a system that allows software and data space to be used from remote locations via a network.

For the maintenance and management of such servers, the administrator and operators perform various operations.

For example, there is known a device having a function to acquire a history of operations performed by the operators, for the purpose of determining the cause in case some failure or trouble occurs. The function makes it possible, in case some failure or trouble occurs, to take an immediate recovery action and countermeasure by analyzing the history of operations.

As an example of a method for acquiring a history of operations, there is one which causes a software for recording the history to run in an Operating System (OS). For example, a technology for recording contents of computer operations is disclosed in Japanese Laid-Open Patent Application No. 2013-140471 (JP2013-140471). However, in the technology disclosed in JP2013-140471, the contents of operations cannot be recorded when an OS is not running in a server. That is, in the technology disclosed in JP2013-140471, it is impossible to record, for example, a Basic Input/Output System (BIOS) setup screen, an operation by a boot loader and the like. Further, the technology has an issue in that no operation at a time of installing the OS can be recorded either.

On the other hand, an example of a technology for recording screen information before and until start-up of an OS is disclosed in Japanese Laid-Open Patent Application No. 2004-302720 (JP2004-302720). In the technology disclosed in JP2004-302720, system information, BIOS start-up information and the like for representing the Central Processing Unit (CPU), the memory capacity and the like, during a time period since start-up of the computer system until start-up of the OS are acquired.

### SUMMARY

As described above, in the technology disclosed in JP2004-302720, history information since start-up of the computer system until start-up of the OS can be acquired, and therefore, history information can be recorded even when the OS is not running. However, in the technology disclosed in JP2004-302720, history information is recorded in the form of a moving image since start-up of the system, which raises an issue in that an operation for acquiring necessary information from the moving image requires much time.

The present invention has been achieved in view of the above-described issue, and accordingly is mainly aimed at providing a server or the like is capable of acquiring information about a process preceding start-up of an OS efficiently.

A server according to the one aspect of the present invention includes:

a control device configured to acquire screen information in response to predetermined input during execution of a process preceding start-up of an OS; and

a storage device configured to store the screen information.

A screen information acquisition method according to the one aspect of the present invention includes:

acquiring screen information in response to predetermined input during execution of a process preceding start-up of an OS; and

storing the screen information into a storage device.

A Baseboard Management Controller (BMC) according to the one aspect of the present invention includes:

a control device configured to acquire screen information in response to predetermined input during execution of a process preceding start-up of an OS; and

a storage device configured to store the screen information.

According to the present invention, an effect of enabling efficient acquisition of information about a process preceding start-up of an OS in a server is achieved.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of a server according to a first example embodiment of the present invention

FIG. 2 is a functional block diagram showing functions of a screen information acquisition circuit of the server according to the first example embodiment of the present invention

FIG. 3 is a diagram showing an example of a hardware configuration for implementing the screen information acquisition circuit of the server according to the first example embodiment of the present invention

FIG. 4 is a flow chart showing operation of the screen information acquisition circuit of the server according to the first example embodiment of the present invention

FIG. 5 is a diagram showing an example of a correspondence table stored in a storage device of a BMC of the server according to the first example embodiment of the present invention

FIG. 6 is a block diagram showing a configuration of a server according to a second example embodiment of the present invention

FIG. 7 is a functional block diagram showing functions of a screen information acquisition circuit and a remote control circuit of the server according to the second example embodiment of the present invention

FIG. 8 is a flow chart showing operation of the server according to the second example embodiment of the present invention

FIG. 9 is a flow chart showing operation of the screen information acquisition circuit of the server according to the second example embodiment of the present invention

FIG. 10 is a block diagram showing a configuration of a server according to a third example embodiment of the present invention

FIG. 11 is a block diagram showing a configuration of a server according to a fourth example embodiment of the present invention

FIG. 12 is a block diagram showing a configuration of a screen information acquisition circuit of a server according to a fifth example embodiment of the present invention

FIG. 13 is a block diagram showing a configuration of a server according to a sixth example embodiment of the present invention

### EXAMPLE EMBODIMENT

Hereinafter, example embodiments of the present invention will be described in detail, with reference to drawings.

### First Example Embodiment

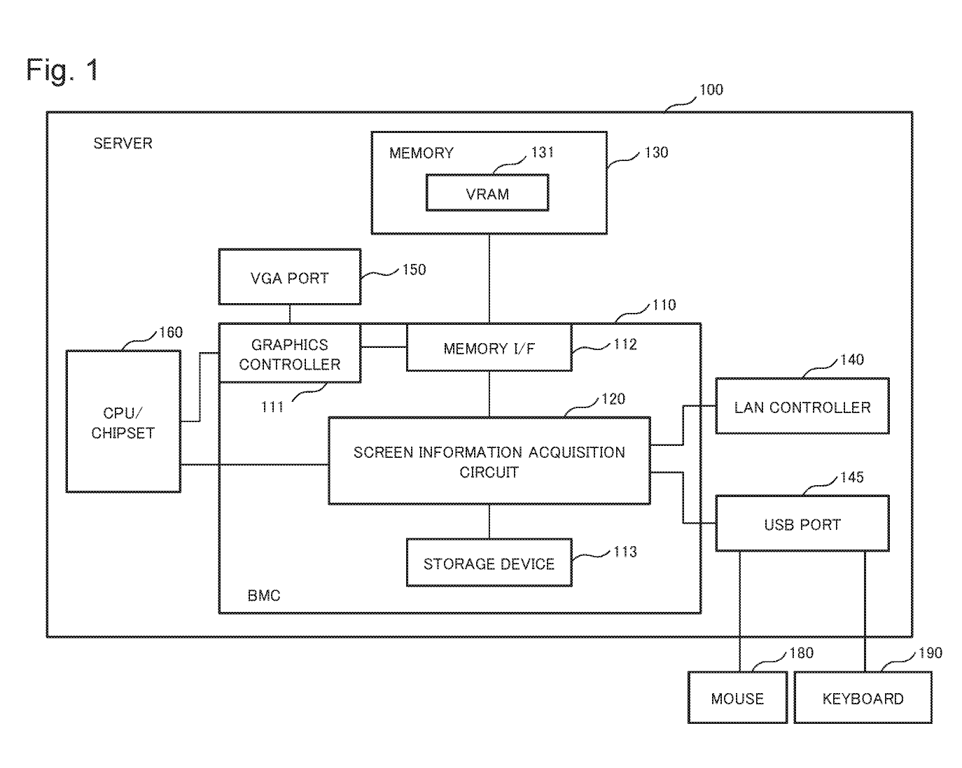

FIG. 1 is a block diagram showing a configuration of a server 100 according to a first example embodiment of the present invention. As shown in FIG. 1, the server 100 according to the first example embodiment includes a BMC 110, a memory 130 and a CPU/Chipset 160.

An outline of functions of each of the components is as follows.

The BMC 110 is a management module of the server 100 and performs management and monitoring of the hardware such as, for example, a CPU and a memory, and monitoring a temperature, voltage, current and the like. To the BMC 110, a Local Area Network (LAN) controller 140, a Universal Serial Bus (USB) port 145 and a Video Graphics Array (VGA) port 150 are connected.

While such a management module of the server 100 as mentioned above will be described to be a “BMC” in the present and following example embodiments, it is just an example. The management module may be, for example, a module referred to as a “ServerView Remote Management Controller” (iRMC) or that referred to as an “Integrated Lights-Out” (iLO).

The memory 130 is a storage device which is accessed at a time of process execution by the BMC 110, and includes a VRAM 131. The VRAM 131 is a storage device for screen outputting of the server 100. While FIG.1 shows the configuration having the memory 130 connected to the BMC 110, a configuration having the memory 130 installed in the BMC 110 may also be employed.

The CPU/Chipset 160 includes a CPU for controlling the overall operation of the server 100 and a chipset for managing such as connections between the CPU and other equipment.

The LAN controller 140 controls data transmission in conformity with the ethernet (registered trademark) standards between the BMC 110 and external devices. The USB port 145 inputs/outputs data in conformity with the USB standards between the BMC 110 and external input/output means such as a mouse 180, a keyboard 190 and the like. The VGA port 150 outputs screen information sent from a graphics controller 111 on a display or the like, which is not illustrated here.

Next, a detailed configuration of the BMC 110 will be described below.

As shown in FIG. 1, the BMC 110 includes the graphics controller 111, a memory interface (hereinafter referred to as a memory I/F) 112, a storage device 113 and a screen information acquisition circuit 120. While the BMC 110 may further include a circuit for performing management and monitoring of the server 100 besides the above-described components, the components relevant to the present invention will be mainly described in the present example embodiment.

The graphics controller 111 controls output of screen information of the server 100 acquired from the VRAM 131 via the memory I/F 112. The memory I/F 112 exchanges data with the memory 130. The screen information acquisition circuit 120 acquires screen information being outputted, by reading from the VRAM 131 data which is currently outputted to the display. The storage device 113 stores the information acquired by the screen information acquisition circuit 120.

In the BMC 110, the graphics controller 111 is connected with the CPU or chipset included in the CPU/Chipset 160 via, for example, a PCIe (Peripheral Component Interconnect express) interface. The screen information acquisition circuit 120 is connected with the CPU or chipset included in the CPU/Chipset 160 via, for example, a USB interface. However, the interfaces between the BMC 110 and the CPU or chipset are not limited to the ones of the above-described standards.

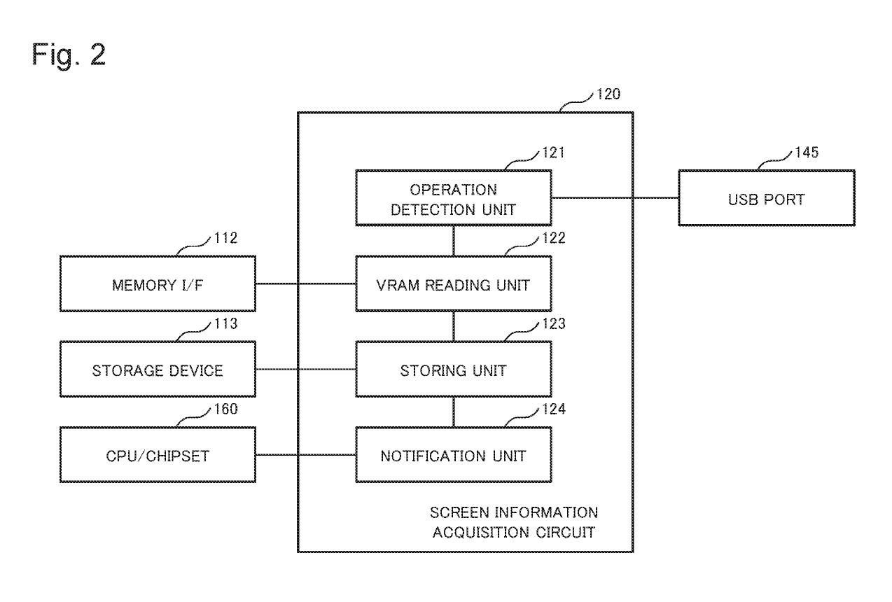

FIG. 2 is a functional block diagram showing specific functions of the screen information acquisition circuit 120 shown in FIG. 1. The screen information acquisition circuit 120 includes an operation detection unit (detection means) 121, a VRAM reading unit 122, a storing unit (storing means) 123 and a notification unit (notification means) 124.

The operation detection unit 121 detects a user operation (input) from an input means such as the mouse 180 or the keyboard 190, inputted via the USB port 145. In response to the detection of a user operation by the operation detection unit 121, the VRAM reading unit 122 reads screen information,via the memory I/F 112, from the VRAM 131 included in the memory 130.

Here, in the VRAM 131, information to be displayed on the screen after power-on of the server 100 has been recorded. Into the VRAM 131, screen information about various processes including those preceding start-up of the OS is stored. Examples of the screen information are: system information about the CPU, the memory capacity and the like; information about a RAID (Redundant Arrays of Inexpensive Disks) setting process; information about a BIOS setting process; and information about start-up from a floppy (registered trademark) disk. The graphics controller 111 reads the above-described screen information from the VRAM 131 via the memory I/F 112, and sends the read screen information to the VGA port 150. The VGA port 150 outputs the acquired screen information on the screen of the display which is not illustrated.

In response to the above-mentioned detection of a user operation (input) by the operation detection unit 121, the VRAM reading unit 122 reads screen information having been stored into the VRAM 131 as described above, via the memory I/F 112. The VRAM reading unit 122 may read, from information having been stored in the VRAM 131, at a time when an operation is detected by the operation detection unit 121, for example, a screen shot (still image), or a moving image during a preset time period after the detection of the operation.

The storing unit 123 stores the screen information read by the VRAM reading unit 122 as described above, into the storage device 113. When the storing unit 123 completes the storing of the screen information into the storage device 113, the notification unit 124 notifies the CPU/Chipset 160 (processing device) of the user operation detected by the operation detection unit 121.

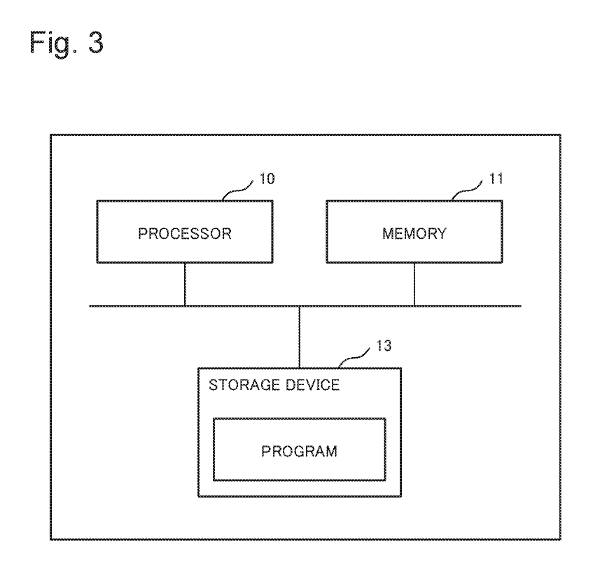

FIG. 3 is a diagram showing an example of a hardware configuration for implementing the screen information acquisition circuit 120 and the memory 130 shown in FIG. 1, and also a screen information acquisition circuit 410, a remote control circuit 210 and a stored information sending circuit 310 which will be described in later example embodiments. Each of the components including the screen information acquisition circuits 120 and 410, the remote control circuit 210 and the stored information sending circuit 310, which are shown in FIG. 2 or later example embodiments, and the memory 130 are implemented by hardware resources illustrated in FIG. 3. The configuration shown in FIG. 3 includes a processor 10, a memory 11 and a storage device 13 storing a program.

Each of the screen information acquisition circuits 120 and 410, the remote control circuit 210 and the stored information sending circuit 310 is implemented by the processor 10 loading to the memory 11 and executing a program for implementing the function of each functional block shown in FIG. 2, 7 or 12, which is stored in the storage device 13.

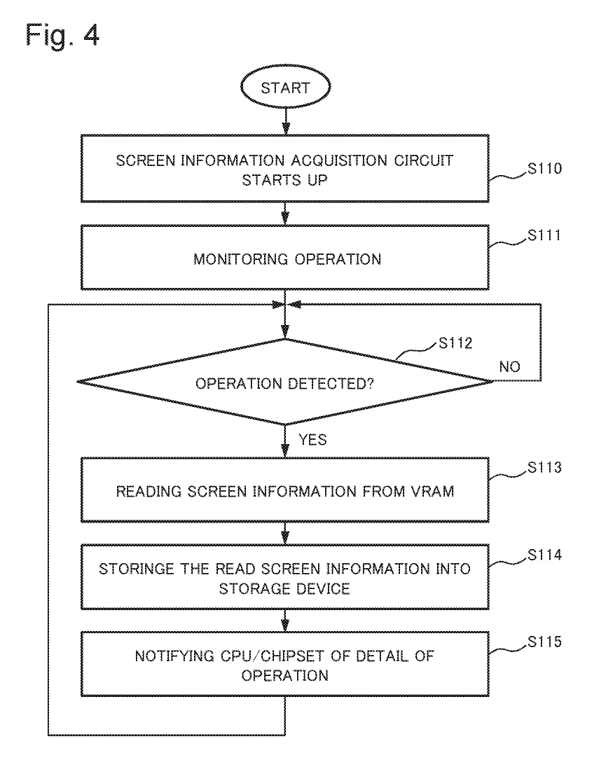

FIG. 4 is a flow chart showing operation of the screen information acquisition circuit 120. With reference to FIG. 4, operation of the screen information acquisition circuit 120 will be described below.

The screen information acquisition circuit 120 starts up in response to power-on of the BMC 110, and the like (S110). After thus starting up, the screen information acquisition circuit 120 monitors, at the operation detection unit 121, the presence or absence of an input of an operation, such as a mouse click or a key input, from the mouse 180 or the keyboard 190 (S111). If detecting such the operation (YES at S112), the operation detection unit 121 notifies the VRAM reading unit 122 of the detection.

In response to the detection of the operation by the operation detection unit 121, the VRAM reading unit 122 reads from the VRAM 131 screen information stored therein, via the memory I/F 112 (S113).

Then, the storing unit 123 stores the screen information read by the VRAM reading unit 122, into the storage device 113 (S114).

After the screen information is stored as described above, the notification unit 124 notifies the CPU/Chipset 160 of the content of the operation detected by the operation detection unit 121, such as the key input or the mouse operation (S115). As a result, the CPU performs a process according to the content of the operation.

Subsequently, the screen information acquisition circuit 120 returns the process to the step S112. By the process having been described above, the screen information acquisition circuit 120 can acquire screen information at a time when an operation is detected.

Alternatively, the VRAM reading unit 122 may perform the reading of screen information depending on the type of an operation detected by the operation detection unit 121. That is, for example, when detecting Enter key input or a left click or when any other arbitrary operation is performed, the operation detection unit 121 may determine that it has detected an input operation, the VRAM reading unit 122 may accordingly read screen information, and the storing unit 123 may store the screen information into the storage device 113. As a result, it becomes possible to store screen information in relation to only predetermined types of operations, and accordingly to reduce the capacity of the storage device 113.

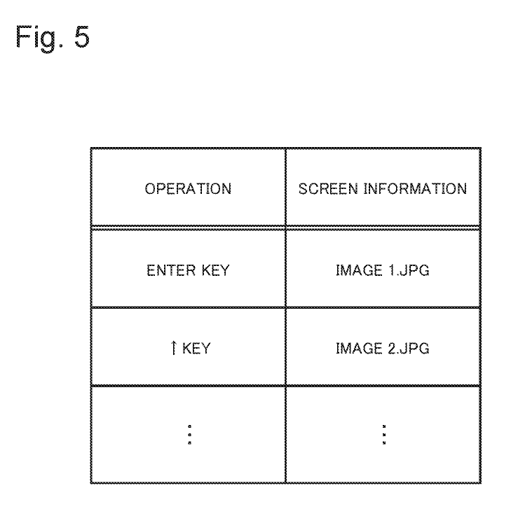

Further, the storing unit 123 may store the operation detected by the operation detection unit 121 and the screen information read by the VRAM reading unit 122 in response to the operation, in a manner to correlate them with each other, into the storage device 113. FIG. 5 is a diagram showing an example of a correspondence table between operations and pieces of screen information, which is stored in the storage device 113. As shown in FIG. 5, such a relation table between operations and pieces of screen information may be stored in the storage device 113. Further, at that time, the notification unit 124 may notify the CPU/Chipset 160 of the correspondence relationship between operations and pieces of screen information. It makes it possible to search for screen information according to the detail of an operation.

As has been described above, according to the present first example embodiment, the server 100 includes the BMC 110 provided with the screen information acquisition circuit 120 which, in response to detection of input from an input means, reads screen information from the VRAM 131 and stores the screen information into the storage device 113. As a result of employing the configuration, according to the present first example embodiment, the server 100 can acquire, by the BMC 110, screen information about a process preceding start-up of an OS in the form of a still image or a moving image during a predetermined time period, which makes unnecessary an operation of retrieving for a desired history of operations from relatively long moving image information, and accordingly produces an effect of enabling efficient acquisition of desired information from the acquired screen information.

Also according to the present first example embodiment, it is possible to achieve an effect that no software for history recording to run within an OS is necessary and screen information about a process preceding start-up of an OS can be acquired without starting up the OS.

Also according to the first example embodiment, the capacity of the storage device for storing image information can be reduced because, as described above, the image information is acquired in the form of the still image or a moving image during a predetermined time period. Further achieved is an effect that screen information including a history of operations can be securely stored even when the capacity of the storage device available for use by the BMC 110 is limited.

### Second Example Embodiment

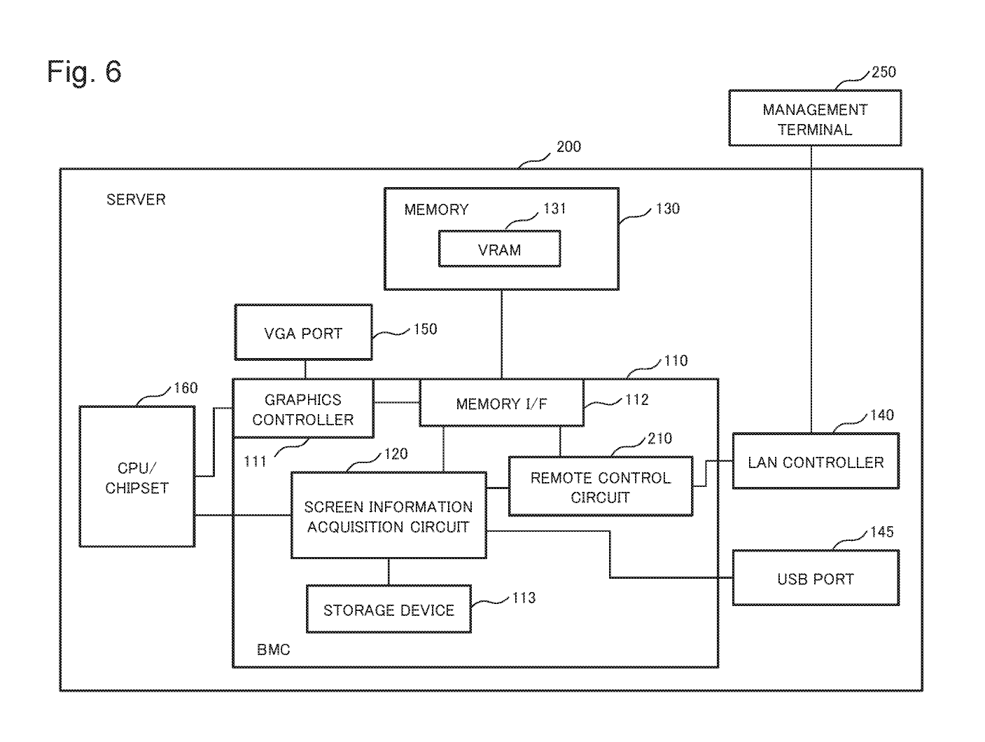

FIG. 6 is a block diagram showing a configuration of a server 200 according to a second example embodiment of the present invention. In the server 200 according to the second example embodiment, the BMC 110 additionally includes a remote control circuit (remote control device) 210, compared to that of the server 100 already described with reference to FIG. 1 in the first example embodiment.

The server 200 is communicably connected with a management terminal 250 via a communication path such as a LAN. The server 200 is remotely operated by the management terminal 250 and, in response to the remote operation, acquires screen information. Here, the connection of the server 200 with the management terminal 250 is not limited to that via a LAN but may be that via another type of interface.

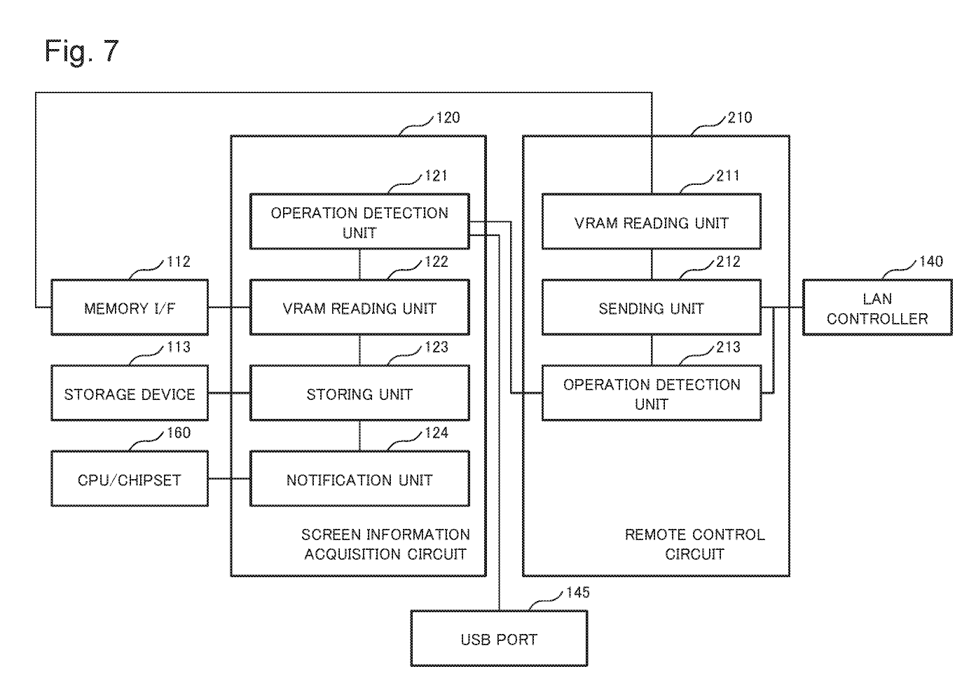

FIG. 7 is a functional block diagram showing functions of the screen information acquisition circuit 120 and the remote control circuit 210. The remote control circuit 210 includes a VRAM reading unit 211, a sending unit 212 and an operation detection unit 213.

The VRAM reading unit 211 reads screen information from the VRAM 131 via the memory I/F 112 periodically or at optional timing. The sending unit 212 sends the screen information read by the VRAM reading unit 211 to the management terminal 250 via the LAN controller 140. On detecting an operation performed at the management terminal 250 via the LAN controller 140, the operation detection unit 213 notifies the operation detection unit 121 of the detection.

The screen information acquisition circuit 120 according to the present second example embodiment is different from the screen information acquisition circuit 120 described in the first example embodiment in that the operation detection unit 121 has a function to acquire an operation which the operation detection unit 213 of the remote control circuit 210 detects from the management terminal 250 via the LAN controller 140. However, the remaining functions are the same as those of the screen information acquisition circuit 120 described in the first example embodiment.

The remote control circuit 210 has a function to acquire a remote operation performed on the server 200 from the management terminal 250 via a network and perform control in response to the acquired operation.

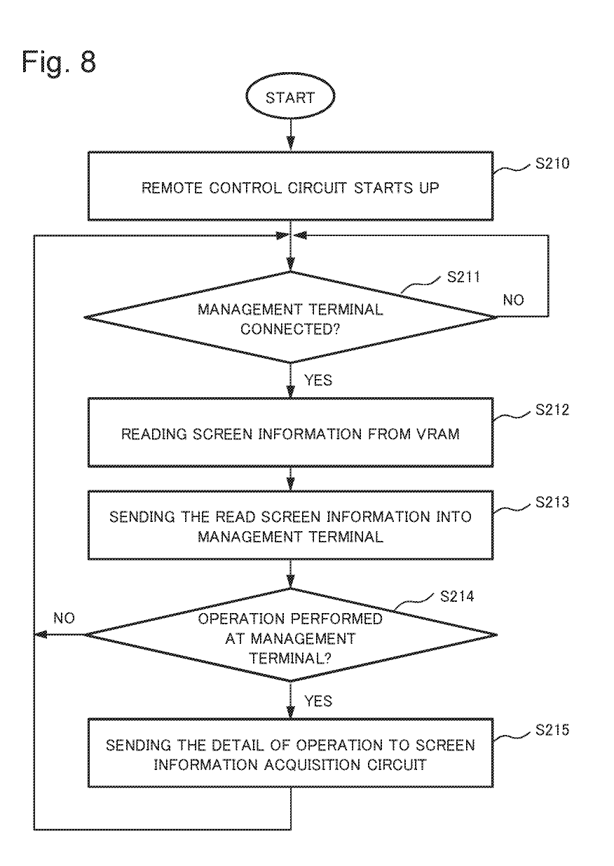

FIG. 8 is a flow chart showing an operation of the server 200 according to the present second example embodiment. The operation of the server 200 will be described below, with reference to FIGS. 7 and 8.

Similarly to the screen information acquisition circuit 120, the remote control circuit 210 starts up in response to power-on of the BMC 110, or the like (S210). After thus starting up, the remote control circuit 210 checks whether the management terminal 250 is connected to the server 200 or not. If the management terminal 250 is connected (YES at S211), the VRAM reading unit 211 reads screen information from the VRAM 131 via the memory I/F 112 periodically or at optional timing (S212).

The sending unit 212 sends the screen information read by the VRAM reading unit 211 to the management terminal 250 via the LAN controller 140. (S213).

At the management terminal 250, the screen information sent from the server 200 is displayed on a display or the like, and an administrator performs an operation. That operation is sent to the remote control circuit 210 via the LAN and the LAN controller 140. If detecting, at the operation detection unit 213, the operation sent via the LAN and the LAN controller 140 (YES at S214), the remote control circuit 210 sends the detail of the operation to the screen information acquisition circuit 120 (S215). Subsequently, the remote control circuit 210 returns the process to the step S211.

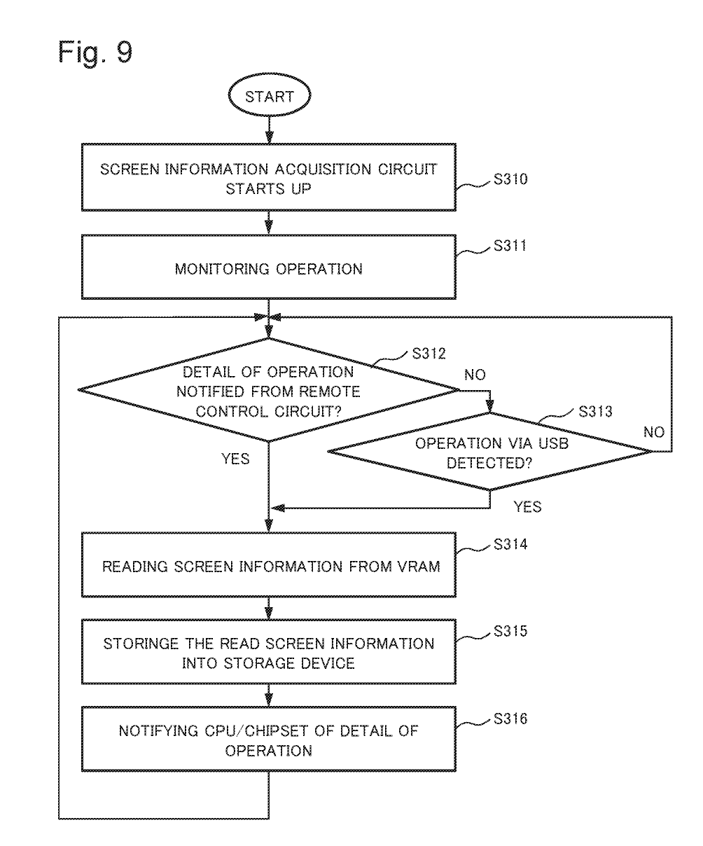

FIG. 9 is a flow chart showing operation of the screen information acquisition circuit 120 in the second example embodiment. The operation shown in FIG. 9 is that obtained by replacing the step S112 in the operation of the screen information acquisition circuit 120 in the first example embodiment, which was described with reference to FIG. 4, with steps S312 and S313.

That is, in monitoring of an operation at the operation detection unit 121 (S311), if receiving notification of a detail of an operation from the remote control circuit 210 (YES at S312) or detecting an operation via the USB port 145 (YES at S313), the screen information acquisition circuit 120 in the second example embodiment reads screen information from the VRAM 131 (S314). Subsequently, the screen information acquisition circuit 120 performs steps S315 and S316, similarly to the steps S114 and S115 in FIG. 4.

As has been described above, according to the present second example embodiment, the BMC 110 of the server 200 includes the remote control circuit 210 which reads screen information from the VRAM 131 periodically or at optional timing and sends it to the management terminal 250 and, in response to detection of an operation performed at the management terminal 250, notifies the screen information acquisition circuit 120 of the detail of the operation. As a result of employing the configuration, according to the present second example embodiment, it is possible to achieve an effect of enabling to read screen information from the VRAM 131 and store it into the storage device 113 in response to not only an operation from the input means directly connected to the server 200 but also an operation from the management terminal 250 connected via the LAN.

### Third Example Embodiment

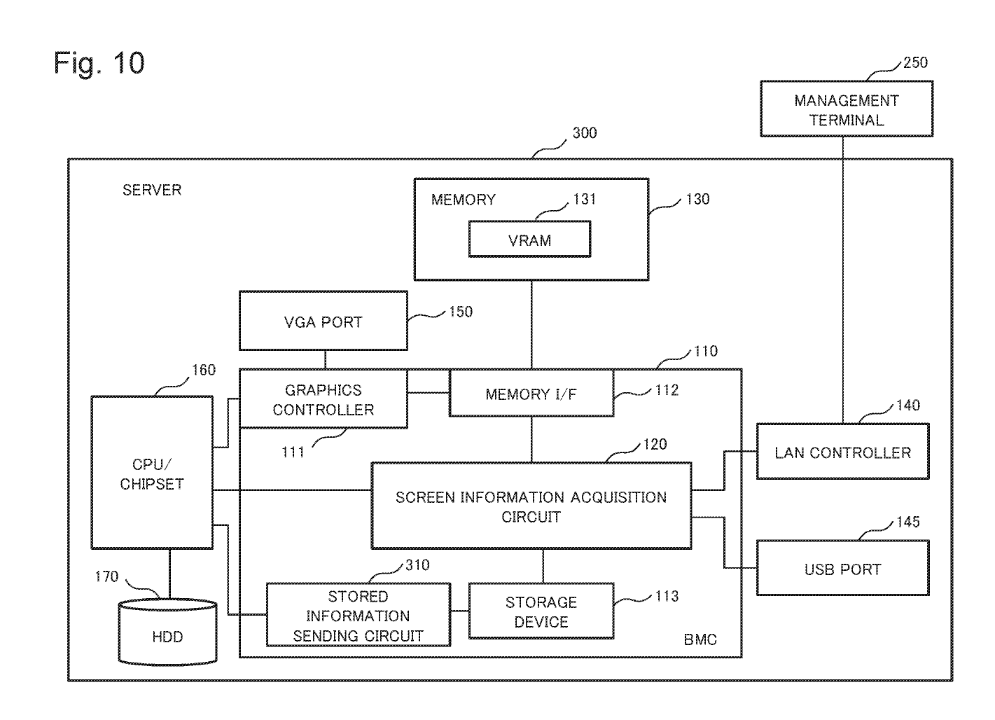

FIG. 10 is a block diagram showing a configuration of a server 300 according to a third example embodiment of the present invention. The server 300 according to the third example embodiment additionally includes a stored information sending circuit (stored information sending means) 310, compared to the server 100 described in the first example embodiment.

Here, the BMC 110 and software running on an OS executed by the CPU included in the CPU/Chipset 160 can communicate with each other via an interface of such as KCS (Keyboard Controller Style) and USB. It is general that the capacities of a memory and a storage area available for use by the BMC 110 are limited.

In that respect, after completion of OS start-up by the CPU, the stored information sending circuit 310 of the server 300 according to the present example embodiment reads screen information from the storage device 113 and sends the screen information to the software running on the OS via, for example, a KCS interface, as necessary or periodically. The software stores the acquired screen information to a storage such as an HDD (Hard Disk Drive) 170 which has sufficient capacity. After that, the stored information sending circuit 310 may delete the sent screen information, from the storage device 113.

As has been described above, according to the present third example embodiment, the stored information sending circuit 310 stores screen information stored in the storage device 113 into another storage via software running on the OS. As a result of employing the configuration, according to the present third example embodiment, it is possible to achieve an effect that acquired screen information can be securely stored even if the capacity of a storage area available for use by the BMC 110 is limited.

### Fourth Example Embodiment

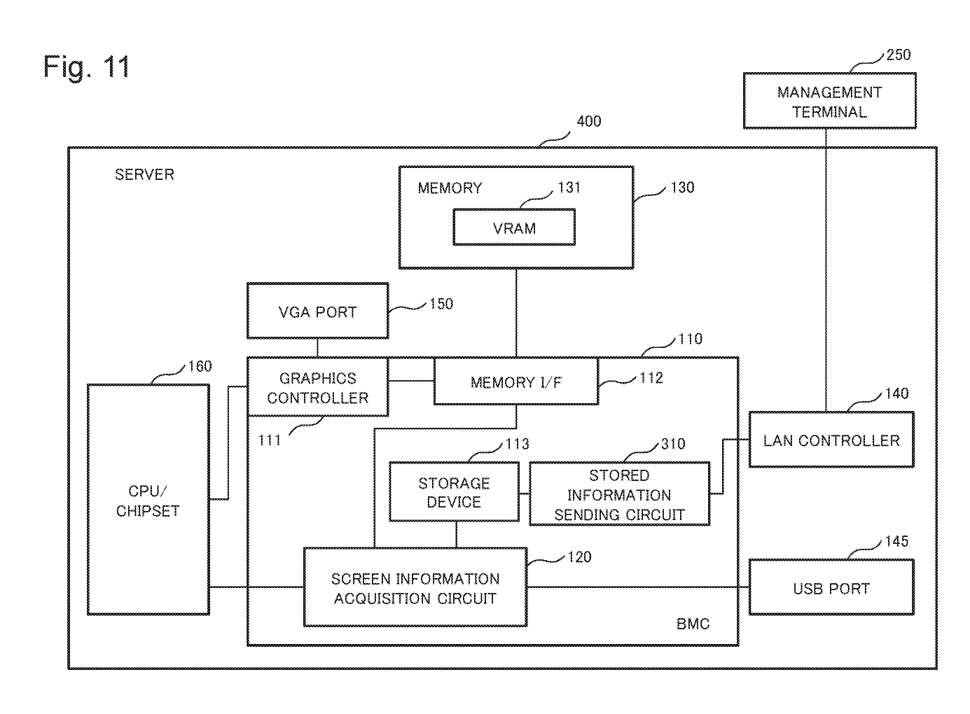

FIG. 11 is a block diagram showing a configuration of a server 400 according to a fourth example embodiment of the present invention. In the server 400 according to the fourth example embodiment, the stored information sending circuit 310 of the server 300 described in the third example embodiment is connected with the LAN controller 140.

The stored information sending circuit 310 sends screen information read from the storage device 113 to the management terminal 250 via the LAN controller 140.

Here, there is a case of using a method in which the management terminal 250 is communicably connected with a plurality of servers, and a BMC installed in each of the plurality of servers is managed by management software installed in the management terminal 250. In the present example embodiment, a description will be given of collecting screen information stored in the storage device 113 of each of one or more servers by using the management terminal 250 configured as described above.

As shown in FIG. 11, the stored information sending circuit 310 sends screen information stored in the storage device 113 to the management terminal 250 as necessary or periodically via the LAN controller 140 by the LAN. After that, the stored information sending circuit 310 may delete the sent screen information, from the storage device 113.

The management terminal 250 having acquired screen information from one or more servers may store a history of operations performed in each of the servers. By the use of the management software, the management terminal 250 may manage the stored screen information and history of operations, and may perform analysis or the like on them.

As has been described above, according to the present fourth example embodiment, in each of the plurality of servers, the stored information sending circuit 310 sends screen information stored in the storage device 113 to the management terminal 250 via the LAN controller 140. As a result of employing the configuration, according to the present fourth example embodiment, it is possible to achieve an effect that screen information and a history of operations in each of a plurality of servers can be managed at the management terminal 250.

### Fifth Example Embodiment

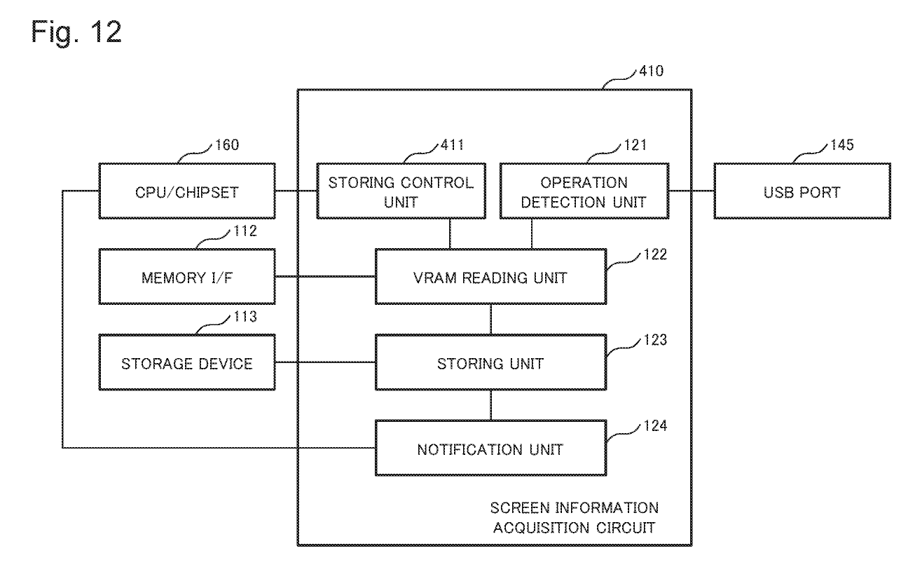

FIG. 12 is a functional block diagram showing functions of a screen information acquisition circuit 410 of a server according to a fifth example embodiment of the present invention. In the present fifth example embodiment, a description will be given of the server including the screen information acquisition circuit 410 shown in FIG. 12 in place of the screen information acquisition circuit 120 of the server 100 according to the first example embodiment.

As shown in FIG. 12, the screen information acquisition circuit 410 additionally includes a storing control unit (storing control means) 411, compared to the screen information acquisition circuit 120 already described in the first example embodiment with reference to FIG. 2.

As mentioned earlier, the BMC 110 and software running on an OS can communicate with each other via an interface of such as KCS and USB. Accordingly, the storing control unit 411 of the screen information acquisition circuit 410 according to the present example embodiment obtains the operation state of the OS via, for example, KCS and controls whether or not to perform reading and storing of screen information, according to the operation state.

For example, by monitoring the operation state of the OS, the storing control unit 411 may instruct the VRAM reading unit 122 to suspend acquisition of screen information before start-up of the OS and to execute acquisition of screen information after start-up of the OS. Alternatively, in the reverse manner, the storing control unit 411 may instruct the VRAM reading unit 122 to execute acquisition of screen information before start-up of the OS, and to suspend acquisition of screen information after start-up of the OS.

For further example, from the viewpoints of security and privacy protection, the storing control unit 411 may instruct to suspend acquisition of screen information about operation during start-up of the OS and to execute acquisition of screen information before start-up of the OS. As a result, it becomes possible to monitor whether or not a user unnecessarily changes the BIOS setup, or the like.

For still further example, the storing control unit 411 may instruct to suspend acquisition of screen information during normal operation, and instruct to execute acquisition of screen information at a time when the BMC 110 detects some anomaly in the server, for example, abnormality in a sensor value. As a result, it becomes possible to store a history of operations only in an abnormal state, and accordingly to reduce the capacity of the storage device 113 and to ease an operation for checking the history.

Further, the storing control unit 411 may monitor the state of the power supply to the server and instruct to suspend acquisition of screen information when the power supply to the server is in the off state. The storing control unit 411 may also instruct to suspend acquisition of screen information when the server is driven by a battery, is operating in a power save mode, and the like, in order to save power. Alternatively, the storing control unit 411 may monitor the state of screen output and instruct to suspend acquisition of screen information when no screen output is present or a black screen is outputted.

As has been described above, according to the present fifth example embodiment, the server includes the storing control unit 411 which controls execution and suspension of acquisition of screen information depending on conditions such as the operation state of the OS and the presence or absence of abnormality in the server, and accordingly, an effect of enabling further reduction in the capacity of the storage device 113 and further easing of an operation for checking a history of operations is achieved.

Here, the screen information acquisition circuit 120 described in each of the example embodiments is not limited to being installed in the BMC 110, but may be installed in the server 100 as a hardware component separated from the BMC 110. In that case, the BMC 110 includes an interface with the screen information acquisition circuit 120, and the screen information acquisition circuit 120 acquires screen information from the VRAM 131 via the BMC 110.

### Sixth Example Embodiment

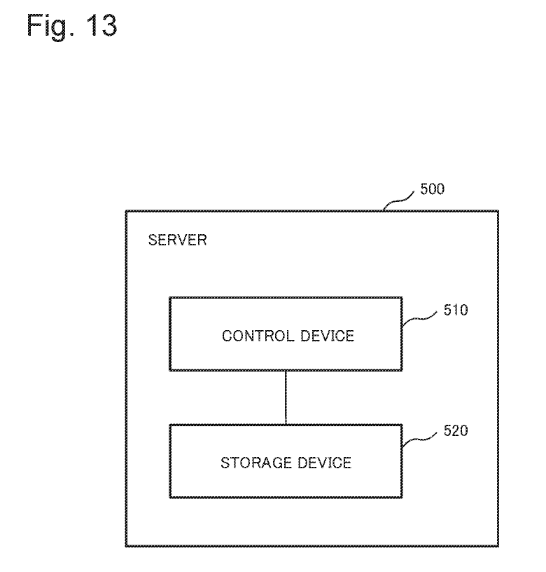

FIG. 13 is a block diagram showing a configuration of a server 500 according to a sixth example embodiment of the present invention. As shown in FIG. 13, the server 500 includes a control device 510 and a storage device 520.

The control device 510 acquires screen information in response to a predetermined input, during execution of a process preceding start-up of an OS. The storage device 520 stores the screen information. Here, the control device 510 may be implemented by, for example, the screen information acquisition circuit 120 in the first example embodiment described earlier.

As has been described above, according to the present sixth example embodiment, as a result of employing the above-described configuration, an operation for checking acquired screen information becomes easy, and accordingly, an effect of enabling efficient acquisition of screen information about a process preceding start-up of an OS is achieved.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

### REFERENCE SIGNS LIST

100, 200, 300, 400, 500 server

110 BMC

111 graphics controller

112 memory I/F

113, 520 storage device

120, 410 screen information acquisition circuit

121, 213 operation detection unit

122, 211 VRAM reading unit

123 storing unit

124 notification unit

130 memory

131 VRAM

140 LAN controller

145 USB port

150 VGA port

160 CPU/Chipset

170 HDD

180 mouse

190 keyboard

210 remote control circuit

212 sending unit

250 management terminal

310 stored information sending circuit

510 control device

1. A server comprising:
a control device configured to acquire screen information in response to a predetermined input during execution of a process preceding start-up of an Operating System (OS); and
a storage device configured to store the screen information.

2. The server according to claim 1, wherein
the control device includes:
one or more processors acting as a detection unit configured to detect the predetermined input; and
a storing unit configured to acquire the screen information and store the screen information into the storage device in response to detection of the input by the detection unit .

3. The server according to claim 2, wherein
in response to the detection of the input, the storing unit reads the screen information to be outputted for screen display and stores the screen information into the storage device.

4. The server according to claim 2, wherein
the storing unit stores the input detected in association with the screen information acquired into the storage device.

5. The server according to claim 3, wherein
the storing unit stores the detected input in association with the acquired screen information into the storage device.

6. The server according to claim 2, wherein
when the detection unit detects an operation of a predetermined type, the detection unit determines that the input is detected.

7. The server according to claim 3, wherein
if detecting a predetermined kind of operation, the detection unit determines that the input is detected.

8. The server according to claim 2, wherein
the process preceding start-up of an OS includes a Basic Input/Output System (BIOS) setting process.

9. The server according to claim 3, wherein
the process preceding start-up of an OS includes a BIOS setting process.

10. The server according to claim 1, further comprising:
a remote control device configured to acquire the screen information, to send the screen information to an external device via a communication path during the execution of a process preceding start-up of an OS, and to notify the control device of an input when the input received from the external device via the communication path is detected.

11. The server according to claim 2, further comprising:
a remote control device configured to acquire the screen information, to send the screen information to an external device via a communication path during the execution of a process preceding start-up of an OS, and to notify the control device of an input if detecting the input from the external device via the communication path.

12. The server according to claim 1, wherein
the control device comprises
one or more processors acting as
a stored information sending unit configured to store the screen information stored in the storage device into a second storage device different from the storage device, after completion of the start-up of an OS.

13. The server according to claim 2, wherein
the control device further comprises
one or more processors acting as
a stored information sending unit configured to store the screen information stored in the storage device into a second storage device different from the storage device, after completion of the OS start-up.

14. The server according to claim 1, wherein
the control device comprises
one or more processors acting as
a storage control unit configured to control execution or suspension of acquisition of the screen information, depending on at least any one of state of the start-up of an OS, presence or absence of anomaly in the server, on or off of server power, and presence or absence of screen output.

15. The server according to claim 2, wherein
the control device further comprises
one or more processors acting as
a storage control unit configured to control execution or suspension of acquisition of the screen information, depending on at least any one of the state of the OS start-up, the presence or absence of abnormality in the server, whether the server is powered on or not, and the presence or absence of screen output.

16. The server according to claim 1, wherein
the control device is installed in a Baseboard Management Controller (BMC) of the server.

17. A screen information acquisition method comprising:
acquiring screen information in response to predetermined input during execution of a process preceding start-up of an OS; and
storing the screen information into a storage device.

18. The screen information acquisition method according to claim 17, wherein
in the acquiring the screen information,
the predetermined input is detected and,
in response to detection of the input, the screen information is acquired and stored into the storage device

19. The screen information acquisition method according to claim 18, wherein
in the storing the screen information,
in response to the detection of the input, the screen information to be outputted for screen display is read and stored into the storage device.

20. A BMC comprising:
a control device configured to acquire screen information in response to predetermined input during execution of a process preceding start-up of an OS; and
a storage device configured to store the screen information.
